(19) United States
(12) Patent Application Publication
(10) Pub. No.: US 2008/0083588 A1
(43) Pub. Date: Apr. 10, 2008

(54) SELF POWERED SELF-HOISTING ELEVATOR APPARATUS

(75) Inventor: Robert L. Leon, Ambler, PA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: LIFE-PACK TECHNOLOGIES, INC., Ambler, PA (US)

(21) Appl. No.: 11/863,615

(22) Filed: Sep. 28, 2007

Related U.S. Application Data
(60) Provisional application No. 60/849,706, filed on Oct. 5, 2006.

(51) Int. Cl. B66B 5/00

(52) U.S. Cl. 187/350

(57) ABSTRACT

A self powered, self hoisting elevator apparatus for lifting objects from a lower supporting surface to or nearer to an origin at a predetermined height in a multistory structure comprises a light weight housing of sufficient strength for receiving and supporting the objects to be lifted. A cable is wound at least partially onto a rotatable member supported by the housing, the cable having a predetermined length sufficient to reach at least from the origin to the lower supporting surface and having a free end for securing the cable to a fixed anchorage proximate to the origin, the rotatable member rotating in a first direction when the housing is descending toward the lower supporting surface. A descent-slowing, energy dissipating mechanism is supported by the housing and driven by rotation of the rotatable member in the first direction, the descent-slowing, energy dissipating mechanism dissipating energy when the housing is descending toward the lower supporting surface to maintain the rate of descent of the housing to be within a predetermined range. A motor is supported by the housing and operatively engaged with the rotatable member for rotating the rotatable member in a second direction, opposite to the first direction, for lifting the housing toward the origin. A power source is also supported by the housing for providing power to the motor. The housing may descend under at least its own unloaded weight toward the lower supporting surface at a descent rate within the predetermined range and when at the lower supporting surface, the housing may be loaded with the objects to be lifted and thereafter the motor may be activated causing the motor to turn the rotatable member to thereby lift the housing toward the origin.

### CROSS REFERENCE TO RELATED APPLICATIONS

This application claims priority from U.S. Provisional Patent Application No. 60/849,706 filed Oct. 5, 2006 and entitled “Failsafe Battery-Powered Self-Hoisting Multi-Trip Anchored Cargo Elevator,” the subject matter of which is hereby incorporated herein by reference.

### BACKGROUND OF THE INVENTION

The present invention relates generally to an elevator apparatus and, more particularly, to a self powered, self hoisting elevator apparatus which is suitable for lifting objects from a lower supporting surface, such as ground level, to or nearer to an origin which is located at a predetermined height in a multistory structure.

When a major fire breaks out on a high or an upper floor of a high-rise building, firefighters, upon arriving on the scene, must haul hose sections, compressed air tanks, and other vital firefighting equipment up multiple stories to a staging floor which is usually two floors below the fire, from which they will launch their attack. The equipment hauling effort may involve up to half of all of the firefighters on the scene and may take a very long time, particularly if the fire is on a high floor. It typically takes at least three minutes for a firefighter hauling up to a hundred pounds of equipment to go up one floor. Thus, it takes more than an hour for a firefighter to haul the same one hundred pounds of equipment up 20 floors, and more than three hours for a firefighter to haul such equipment up 60 floors. So by the time the firefighting equipment gets to where it is needed to fight the fire, the fire may be way out of control. Also, when the hauling firefighters finally get the equipment to the staging floor they are often too exhausted to participate in the firefighting effort itself. Furthermore, the firefighters trudging up the fire stairways with the equipment can significantly impede the building occupants trying to come down those same stairways.

What is needed is a faster and more efficient way to get vital firefighting equipment up to a high staging floor without consuming so many firefighters in the effort, and without potentially clogging the fire stairways impeeding the exiting of building occupants: a way that does not require the use of building elevators or building power which is typically shut off and is likely to not be available in a fire or other emergency situation; a way that is practical and cost-effective for both building owners and firefighters to implement, and is failsafe for the people in the building and on the ground.

The present invention, in the preferred embodiment, addresses these needs by providing a cargo carrier or elevator apparatus that can move up and down the outside of a building, utilizing a passive energy dissipation mechanism for slowing descents and a battery powered motor to power the ascents with a slow failsafe descent if the battery power runs out during an ascent cycle. The preferred embodiment of the present invention utilizes a cable that is anchored at or above the staging floor or the elevation to which the equipment is to be hauled within the building, a cable spool whose rotation during the descents drives the energy dissipation mechanism, and a motor powered by the battery to rewind the cable spool, either directly or indirectly during the ascents, where the control of the motor may be by a wireless controller. The attached cargo bin includes at least one openable hatch for loading and unloading the cargo into the bin. Although the ferrying of vital firefighting equipment is an important application of the present invention, other applications also exist. One such application in the construction industry, for example, is the ferrying of materials up to a high elevation work site where installing a traditional power-line powered elevator may be impractical.

### BRIEF SUMMARY OF THE INVENTION

Briefly stated, the present invention comprises a self powered, self hoisting elevator apparatus for lifting objects from a lower supporting surface to or nearer to an origin at a predetermined height in a multistory structure. The apparatus comprises a light weight housing of sufficient strength for receiving and supporting the objects to be lifted and a cable wound at least partially onto a rotatable member supported by the housing, the cable having a predetermined length sufficient to reach at least from the origin to the lower supporting surface and having a free end for securing the cable to a fixed anchorage proximate to the origin. The rotatable member rotates in a first direction when the housing is descending toward the lower supporting surface. A descent-slowing, energy dissipating mechanism is supported by the housing and is driven by rotation of the rotatable member in the first direction. The descent-slowing, energy dissipating mechanism dissipates energy when the housing is descending toward the lower supporting surface to maintain the rate of descent of the housing to be within a predetermined range. A motor supported by the housing and operatively engaged with the rotatable member is provided for rotating the rotatable member in a second direction, opposite to the first direction, for lifting the housing toward the origin. A power source supported by the housing provides power to the motor. The housing may descend under at least its own unloaded weight toward the lower supporting surface at a descent rate within the predetermined range. When at the lower supporting surface, the housing may be loaded with the objects to be lifted and thereafter the motor may be activated causing the motor to turn the rotatable member to thereby lift the housing toward the origin.

In another embodiment the present invention comprises a method of lifting objects from a lower supporting surface to or nearer to an origin at a predetermined height in a multistory building, the method comprising: storing at or near the origin a light weight housing of sufficient strength for receiving and supporting the objects to be lifted, the housing including a cable wound at least partially onto a rotatable member supported by the housing, the cable having a predetermined length sufficient to reach at least from the origin to the lower supporting surface and having a free end for securing the cable to a fixed anchorage proximate to the origin, the rotatable member rotating in a first direction when the housing is descending toward the lower supporting surface and a descent-slowing, energy dissipating mechanism supported by the housing and driven by rotation of the rotatable member in the first direction, the descent-slowing, energy dissipating mechanism dissipating energy when the housing is descending toward the lower supporting surface to maintain the rate of descent of the housing to be within a predetermined range; securing the free end of the cable to the fixed anchorage; dropping the housing out of a window or other opening in the building so that the housing descends under at least its own weight toward the lower supporting surface at a descent rate within the predetermined range; at the lower supporting surface securing a motor and a power source to the housing, the motor being supported by the housing and operatively engaged with the rotatable member for rotating the rotatable member in a second direction, opposite to the first direction, for lifting the housing toward the origin and the power source supported by the housing for providing power to the motor; loading the housing with the objects to be lifted; and activating the motor to lift the housing with the objects toward the origin

### BRIEF DESCRIPTION OF THE SEVERAL VIEWS OF THE DRAWINGS

The foregoing summary, as well as the following detailed analyses of the physical principals and detailed description of the preferred embodiment will all be better understood when read in conjunction with the appended drawings. For the purpose of illustrating the invention, particular arrangements and methodologies are shown in the drawings. It should be understood, however, that the invention is not limited to the precise arrangements shown or the methodologies of the detailed description. In the drawings:

FIG. 1 is a side elevational view which shows a descent unit in accordance with a preferred embodiment of the present invention starting its initial descent with its cable anchored to an interior building column;

FIG. 2 is an explodes perspective view of the descent unit/elevator apparatus in accordance with the preferred embodiment; and

FIG. 3 is a side elevational view which shows a fully-assembled elevator apparatus in accordance with the embodiment shown in FIG. 2 with the cargo bin full of compressed air tanks ascending up the side of a building.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the self powered, self hoisting elevator apparatus and designated parts thereof. Unless specifically set forth herein, the terms “a”, “an” and “the” are not limited to one element but instead should be read as meaning “at least one”. The terminology includes the words noted above, derivatives thereof and words of similar import.

Referring now to the drawings, wherein the same reference numerals are used to designate the same structural features throughout the several figures there is shown a preferred embodiment of the present invention used for lifting firefighting equipment to high floors in a building. It will be appreciated that the present invention is capable of being used in other applications. For example, an embodiment of the present invention may be used for lifting materials and tools to a high floor of a building being constructed in a situation where a conventional construction elevator cannot be used.

The present invention, when used for the aforementioned fire equipment ferrying application, comprises a pre-stored passive descent unit 1 comprising a housing 1a and other parts hereinafter described which are preferably supported by the descent unit housing 1a when the descent unit 1 reaches the ground or other lower supporting surface and which convert the descent unit 1 to a self powered, self hoisting elevator apparatus 6 or ascent/descent system. One or more such descent units 1 can be pre-stored on one or more and preferably each upper floor of a high rise building 10. Alternatively completely assembled elevator apparatuses 6 may be stored on one or more upper floors of a building 10. As a further alternative, a completely assembled elevator apparatus 6 is stored at or near the ground or other supporting surface or is transported to the building 10 from some other location. Then, the free end of the elevator apparatus cable 14 is raised to the origin using a rope or some other device and is secured to a fixed anchorage as described below.

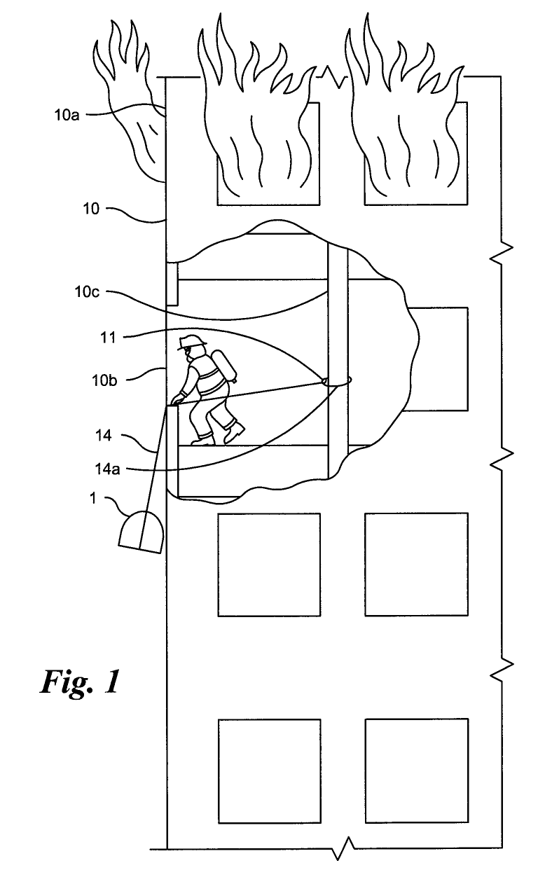

With the preferred embodiment, when a fire breaks out on an upper floor 10a of the building 10, responsible personnel in the building 10 or arriving firefighters go to the floor below the fire floor 10b (referred to as an origin) and affix the free end 14a of a cable 14 of a pre-stored descent unit 1 to a fixed anchorage such as an available structural column 10c using an attachment device such as a carabiner 11 which has been secured to the free end 14a of the cable 14. Although a carabiner 11 is used in the present embodiment it will be appreciated by those skilled in the art that any other suitable attachment device such as a hook, a snap hook or the like could alternatively be used. Additionally, although in the present embodiment the free end of the cable 14a is secured to a building column 10c it will be apparent to those skilled in the art that any other available fixed anchorage may alternatively be used. The responsible personnel or firefighters would then open or break a building window if necessary and start the descent unit 1 descending toward the ground or other lower supporting surface (See FIG. 1) under its own unloaded weight. If there is a building setback on a lower floor, one or more other personnel or firefighters would go out onto the roof of the setback and drop the descent unit 1 over the setback edge of the building 10 to continue its descent to the ground or other lower supporting surface. As the descent unit 1 descends toward the ground or other supporting surface, the cable 14 which is initially at least partially wound onto a rotatable member such as a cable spool 13 rotatably supported by the housing 1a is played out from the cable spool 13 as the cable spool 13 rotates in a first direction. A descent slowing, energy dissipating mechanism 20 also supported by the housing 1a is driven, in a manner described below, by the rotation of the cable spool 13 in a first direction for dissipating energy as the descent unit 1 descends toward the lower supporting surface to maintain the rate of descent of the descent unit 1 to be within a predetermined range.

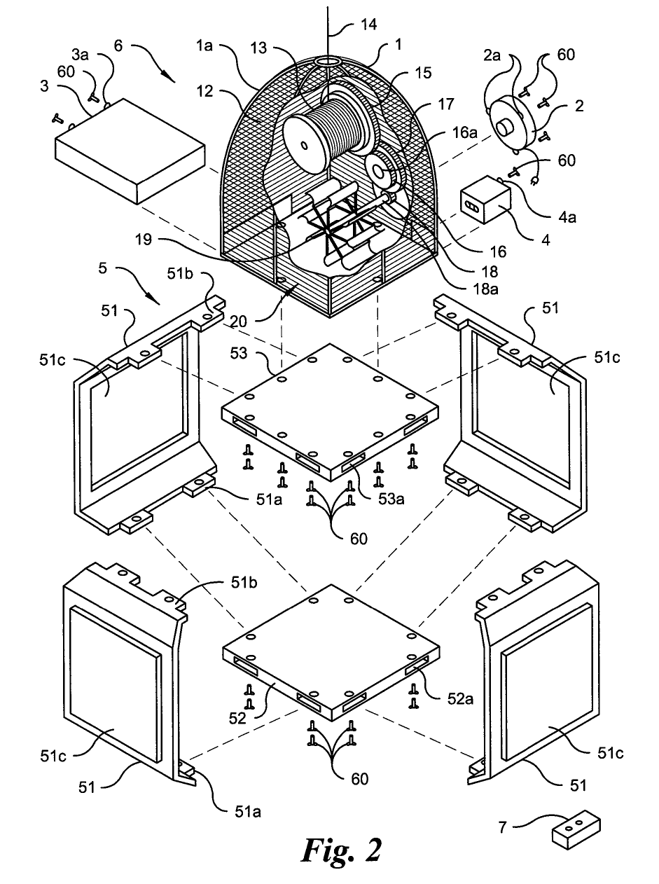

Once the descent unit 1 initially reaches the ground or other lower supporting surface, other personnel or firefighters attach a motor 2, a power source, such as a battery pack 3, a controller such as a wireless remote controller 4 which interconnects the motor 2 and the battery pack 3 and an object receiving cargo bin 5 to the descent unit housing 1a to complete the elevator apparatus or ascent/descent system 6 (See FIG. 2). The motor 2 is preferably an electric motor but could be some other kind of motor such as a pneumatic motor, an air motor or the like. The power source in the present embodiment is a battery pack 3 but could be some other power source such as an air tank, gas tank or the like. Preferably the battery pack 3 is secured to the descent unit housing 1a using one or more wing nuts 60 which extend through one or more lugs or ears 3a on the battery pack 3 but other attachment devices could be used. The motor 2 is nonrotatably supported by the housing 1a using any suitable attachment mechanism such as one or more wing nuts 60 which extend through one or more lugs or ears 2a on the motor 2, one or more clamps, one or more clips, tabs or the like. The motor 2 is operatively engaged with the cable spool 13 for rotating the cable spool 13 in a second direction, opposite to the first direction, for winding the cable 14 back onto the cable spool 13 to thereby lift the elevator apparatus 6 upwardly toward the origin. The motor 2 may be decoupled or disengaged from the cable spool 13 during descent of the elevator apparatus 6 if desired. Alternatively the motor 2 could remain coupled during descent and could function as a generator to recharge the battery pack 3. In the present embodiment the output shaft of the motor 2 is mechanically connected using, for example a spline or key connection or the like, to a shaft 18a (described below) which in turn is gear connected (described below) to the cable spool 13. The output shaft of the motor 2 may be operatively coupled to the cable spool 13 in some other manner if desired. The wireless controller 4 is preferably secured to the descent unit housing 1a using one or more wing nuts 60 which extend through one or more lugs or ears 4a on the wireless controller 4 but any other suitable attachment device could be used.

In the preferred embodiment, the cargo bin 5 is comprised of four substantially identical vertical side panels 51 and a base panel 52 which are attached together and are attached to a top panel 53 which is also attached to the descent unit housing 1a. In the present embodiment the components of the cargo bin 5 are made of a light weight, high strength material such as Lexan®. Other materials may alternatively be used. In the present embodiment the side panels 51 each include one or more bottom lips 51a each of which is inserted into corresponding slots or grooves 52a in the bottom panel 52. The side panels 51 are also each latched to the bottom panel 52 using suitable latching mechanisms such as wing nuts 60. Similar lips 51b along the tops of the side panels 51 are inserted into corresponding slots or grooves 53a in the top panel 53. The side panels 51 are also latched to the top panel 53 using suitable latching mechanisms such as wing nuts 60. In this manner the cargo bin 5 is securely held together. It will be appreciated that the cargo bin 5 may be held together in some other manner such as using snap or detent connections or the like. Alternatively, the components of the cargo bin 5 may be permanently secured together such as by the use of an adhesive, welding or the like. The assembled cargo bin 5 is preferably attached to the descent housing 1a using suitable latching mechanisms such as wing nuts 60 or in any other suitable manner. Preferably the side panels 51 each include windows 51c which may slide open/closed with respect to the cargo bin 5 to facilitate installation/removal of the cargo from any of the sides of the cargo bin 5 which may face a building window opening.

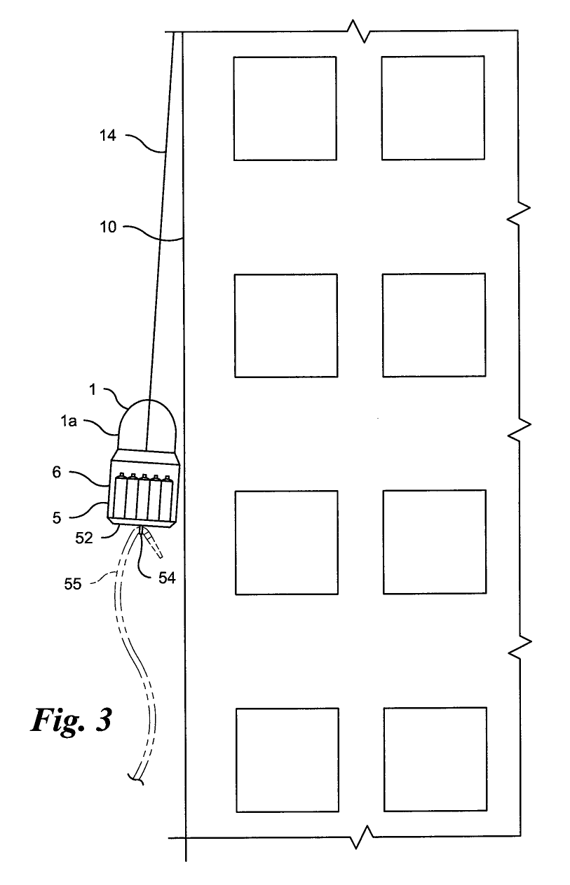

When the cargo bin 5 is assembled and attached to the descent unit housing 1a the cargo bin 6 may be loaded with objects such as air tanks, hose sections, and other vital firefighting equipment to be lifted upwardly. Using a wireless transmitter/controller 7 which is in wireless contact with the wireless controller 4, the motor 2 is activated thereby rotating the cable spool 13 in the second direction to rewind the cable 14 and raise the elevator apparatus 6 (See FIG. 3) shown fully loaded with 25 air tanks. A greater or lesser number of air tanks, hose sections or other equipment may alternatively loaded into the elevator apparatus 6. The elevator apparatus 6 is lifted upwardly along the outside of the building 10 until it reaches a window or other opening at a staging floor which is preferably at least two stories below the fire floor and one story below the origin or the floor containing the column 10c anchoring the free end 14a of the cable 14. The motor 2 is then stopped using the wireless transmitter/controller 7 to stop the upward movement of the elevator apparatus 6 and a brake, preferably actuated by locking the motor 2 is applied to hold the elevator apparatus 6 at the level of the window or other building opening of the staging floor to facilitate unloading of the lifted equipment. Through the second opened or broken window (not shown) or other building opening at the staging floor, the cargo bin 5 is then opened, preferably by sliding to the side the moveable window 51c of the vertical side panel 51 closest to the building 10 to provide access to the interior of the cargo bin 5. The lifted equipment may then be removed from the cargo bin 5 for use in fighting the fire. After the fire fighting equipment has been removed from the cargo bin 5, the opened vertical side panel 51 is closed, the brake is released, and the emptied elevator apparatus 6 passively descends under its own weight at a controlled descent rate within the predetermined range toward the supporting surface in the manner described above to be reloaded with additional equipment to be lifted, and then the foregoing cycle is repeated as needed. In some high fire instances, particularly in buildings under construction or demolition, the existing standpipe system in the building may be non-existent or inoperable. In such cases, the nozzle end of a long fire hose may be affixed to the elevator apparatus 6, preferably to the bottom panel 52 by a suitable attachment mechanism (not shown) and hauled up to the staging floor or to the origin so that water from below may be applied through the lifted fire hose directly to the fire.

The descent unit 1 of the preferred embodiment of present invention is based upon the apparatus for the safe, slow descent of a person from a multistory building as described in U.S. Pat. No. 6,962,235 entitled “Apparatus for the Exterior Evacuation from Buildings”, the entire subject matter of which is hereby incorporated herein by reference. The descent unit 1 of the preferred embodiment utilizes essentially the same energy dissipating mechanism as used in the described preferred embodiment of U.S. Pat. No. 6,962,235 albeit with some of the component parts arranged differently, to accomplish the controlled slow descent, and it employs at least some of the same safety features.

As best shown in FIG. 2, in the preferred embodiment, the descent unit housing 1a is comprised of a protective mesh or screen 12 preferably formed of steel or aluminum which allows for the free flow of air in and out of the housing 1a, as it descends or is lifted along the side of the building 10. Other materials may be used to form the descent unit housing 1a if desired. The fact that the cable 14 is played out from or wound onto the cable spool 13 as the descent unit housing 1a or elevator apparatus 6 moves up and down along the side of the building 10 and the cable 14 is not moving is a major advantage of the present invention, since this feature lessens the chance of the cable 14, the descent unit housing 1a or the elevator apparatus 6 of becoming entangled in any protuberances along the side of the building 10. Also lessening the chance of entanglement is the exterior shape of the preferred embodiment of the descent unit housing 1a. Preferably, as shown in FIGS. 1-3, the descent unit housing 1a a four-sided generally raindrop shape, sort of like a light bulb but with square rather than round cross sections. The squared generally flat sides allow the descent unit housing 1a to slide along the side of the building 10 without rotating, countering any tendency of the cable 14 which might otherwise tend to cause rotation of the descent housing 1a or the elevator apparatus 6. The light bulb shape also lets the descent unit housing 1a pass easily by building protuberances in either direction and enables multiple ascending and descending descent units 1 or elevator apparatuses 6 to pass easily by each other as well. When an ascent/descent unit 1 or elevator apparatus 6 descends to a building setback, firefighters or other persons are needed to drag the light (emptied) descent unit 1 or elevator apparatus 6 to the edge of the setback and over the side of the building 10. However, when a loaded elevator apparatus 6 ascends to a building setback, no assistance is needed to drag it over to the setback wall so it can continue up the side of the building 10 since the motor 2 will accomplish that automatically.

The cable spool 13 in the preferred embodiment is initially wound with a full compliment of high strength cable 14, preferably made of steel wire rope, which is sufficiently long to reach from the installation floor 10b or origin down to the ground or other lower supporting surface, taking into account the maximum attachment length to the anchor column 10c on the installation floor, and any slant heights that result from any building setbacks or other potential obstructions. The cable spool 13 which is supported for rotation within the descent housing 1a mechanically connects to a large spur gear 15 through a clutch mechanism (not shown) which is designed to slip whenever the torque exceeds a preset limit, corresponding to when the cable force exceeds a preset safety limit of, for example, 650 lbs when the cable spool 13 contains its full allotment of cable 14, thereby limiting the force resulting from any initial free-fall of the descent unit 1 or elevator apparatus 6. The large spur gear 15 meshes with a smaller spur gear 16 located on an intermediate shaft 16a and a larger spur gear 17 on the intermediate shaft 16a in turn meshes with another smaller spur gear 18 located on a third shaft 18a which contains a high speed air impeller 19. The two gear meshes result in a total rotational speed multiplication of approximately 30, and thus the rotational speed of the air impeller 19 will be approximately 30 times the rotational speed of the cable spool 13. According the teachings of U.S. Pat. No. 6,962,235, it is the geared-up high speed of the air impeller 19 in conjunction with the slow play-out of the cable 14 from the cable spool 13 that efficiently dissipates the energy from the descent of the descent unit 1 or the elevator apparatus 6 and results in a slow descent speed. Calculations show that if the cable spool 13 has an average wound cable diameter of about 7.5 inches, and with the above described speed multiple of 30 for the air impeller 19, then an air impeller 19 of a similar diameter can be fashioned to rotate at about 900 RPM and keep the descent speed of a 400 pound total weight (maximum load) to an average of about 2 feet per second. And if the total weight were to be only 100 pounds (unloaded, for instance), the average descent speed would not decrease fourfold, but only twofold to about 1 foot per second. If desired some other gear arrangement or other transmission mechanism may be used to operatively connect the cable spool 13 to the air impeller 19. Further, in an alternate embodiment the energy dissipating mechanism may comprise a device other than the air impeller 19.

The above parameters may be used to form the basis of the design of a practical elevator apparatus 6, with the descent unit 1 containing an average amount of cable 14, the motor 2, controller 4 and battery pack 3, and empty cargo bin 5 would weigh about 100 pounds. Thus when the cargo bin 4 is loaded with about 300 pounds of cargo, the entire assembly would weigh about 400 pounds. The empty elevator apparatus 6 would descend at an average speed of about one foot per second, and fully loaded the elevator apparatus 6 would descend at an average speed of about two feet per second. Thus, if the battery-pack 3 should happen to run out of energy or otherwise fail while the fully loaded elevator apparatus 6 is ascending, the loaded elevator apparatus 6 would simply descend at the still-very-slow and safe speed of about two feet per second. Therefore, the present invention it considered to be failsafe.

With a fully charged battery pack 3, an electric motor 2 turning the air impeller shaft 18a in the reverse direction at 1,620 RPM would drive the elevator apparatus 6 upwardly at an average speed of about 1.8 feet per second. When the elevator apparatus 6 is loaded with 300 pounds of material, making its total weight about 400 pounds, achieving this climbing speed will require about 900 watts of power, which is equivalent to about 1.2 horsepower. A relatively small size motor that can satisfy this requirement is the Kollmorgen Servo-Disc motor, Model U16M4H which measures 7.4″ diameter×3″ long and weighs 18.7 pounds. With air cooling (from the impeller 19), this motor can achieve the required speed and torque, drawing about 12 amps with about 90 VDC input.

The battery-pack 3 must supply sufficient voltage and current for the operation of the motor 2. A model PA3383U-1BRS lithium ion 12 cell laptop computer battery can supply up to 6 amps at 14.8 volts. The ascent requirement specified above might necessitate using twelve (12) such 14.8 volt rechargeable batteries, six-in-series in parallel with another six-in-series, to supply up to 12 amps at about 89 volts. Each laptop battery is able store up to 6.45 ampH, so it can supply the necessary 6 amps for at least an hour, or 3,600 seconds. At 1.8 feet per second, 3,600 seconds is equivalent to 6,480 feet, and since the typical building story is between 9 feet and 14 feet (12.5 feet average), the fully loaded elevator apparatus 6 should be able to ascend at least 500 average stories using twelve of the laptop batteries wired as described above to make up the required ascent battery pack 3. Each of the laptop batteries is 10.75″×2.9″×1.05″ and weighs 1.4 lbs, so the ascent battery pack 3 comprising twelve such batteries would measure 10.75″×2.9″×12.6″ and weigh about 16.8 pounds.

All of the above could alternatively be achieved with a less expensive golf cart motor such as the Cushman CZ383, and sealed glass mat 12 volt batteries, but these components would be much larger and weigh more than the 35.5 pounds total for the components described in the previous paragraphs.

The preferred embodiment preferable employs as the cable 14 0.125 inch diameter 7×19 configuration galvanized aircraft cable which has a minimum breaking strength of 2,000 pounds and weighs about 2.9 lbs per hundred feet. Thus, thirty stories worth of cable would be about 375 feet long and would weigh about 10.9 pounds. Fifty stories worth of cable would be about 625 feet long and would weigh about 18.1 pounds. Seventy stories worth of cable would be about 875 feet long and would weigh about 25.4 pounds. Ninety stories worth of cable would be about 1,125 feet long and would weigh about 36.2 pounds. One-hundred-ten stories worth of cable would be about 1,375 feet long and would about weigh 40 pounds. Therefore, for most embodiments the initial cable weight will be 25±15 pounds, and since the played-out cable 14 will be no longer descending, the total descending weight will decrease as the elevator apparatus 6 descends along the side of the building 10.

As indicated previously, if the battery pack 3 should run out of power while a fully loaded elevator apparatus 6 is ascending, the elevator apparatus 6 will simply descend at a low speed back to the ground or other lower supporting surface in a failsafe manner. There the drained battery pack 3 can be quickly and conveniently replaced with a fully charged, fresh battery pack 3 and the ascents and descents of the elevator apparatus 6 can be resumed. If there is a building setback located below where the battery pack 3 runs out of power, the choices are to: 1) empty the cargo bin 5 and drag the elevator apparatus 6 to the edge and over to permit it to descend to the ground or other lower supporting surface to receive a fresh battery pack 3, 2) try to a accomplish the same result without emptying the bin 5, or 3) carry a fresh replacement battery pack 3 along with the cargo at all times so the battery pack 3 can be replaced on the setback. The third option should be considered the preferred option whenever there is a building setback along the route of the elevator apparatus 6.

The wireless transmitter/controller 7 used to control the elevator apparatus 6 may be a very simple device not substantially different than the inexpensive controllers model airplane flyers use to control model planes in flight. Control functions preferable include: motor on/motor off, brake on/brake off. Multiple control options exist as follows: 1) use of a single wireless transmitter/controller 7 on the ground, 2) use of two wireless transmitter/controllers 7, one on the ground and one up at the origin or staging floor, so that the closest controller (strongest signal) takes precedence, 3) use of multiple wireless transmitter/controllers 7 one on the ground, one up at the origin or staging floor, and one on each building setback, where again the closest wireless transmitter/controller 7 takes precedence.

As shown in FIG. 3, the lower surface of the bottom panel 52 includes a clip, clamp or other attachment member 54 for receiving and retaining the distal or nozzle end of a fire hose 55. In this manner the fire hose 55 may be lifted to the staging floor by the elevator apparatus 6 so the fire hose 55 may be used to assist in fighting the fire using water or some other suitable fire fighting fluid from the ground or other lower surface.

Although the preferred embodiment of the failsafe self-powered self-hoisting multi-trip anchored elevator apparatus has been described and specified in significant detail for the fire equipment ferrying application, alternate arrangements and other applications still within the scope of the present invention are feasible. It will also be appreciated by those skilled in the art that alternate uses may be found that differ from the proposed use, and changes or modifications could be made to the above-described embodiment without departing from the broad inventive concepts of the invention. Therefore it should be appreciated that the present invention is not limited to the particular use or particular embodiments disclosed but is intended to cover all uses and all embodiments within the scope or spirit of the described invention as defined by the appended claims.

It is claimed:

1. A self powered, self hoisting elevator apparatus for lifting objects from a lower supporting surface to or nearer to an origin at a predetermined height in a multistory structure, the apparatus comprising:
a light weight housing of sufficient strength for receiving and supporting the objects to be lifted;
a cable wound at least partially onto a rotatable member supported by the housing, the cable having a predetermined length sufficient to reach at least from the origin to the lower supporting surface and having a free end for securing the cable to a fixed anchorage proximate to the origin, the rotatable member rotating in a first direction when the housing is descending toward the lower supporting surface;
a descent-slowing, energy dissipating mechanism supported by the housing and driven by rotation of the rotatable member in the first direction, the descent-slowing, energy dissipating mechanism dissipating energy when the housing is descending toward the lower supporting surface to maintain the rate of descent of the housing to be within a predetermined range;
a motor supported by the housing and operatively engaged with the rotatable member for rotating the rotatable member in a second direction, opposite to the first direction, for lifting the housing toward the origin; and
a power source supported by the housing for providing power to the motor
whereby the housing may descend under at least its own unloaded weight toward the lower supporting surface at a descent rate within the predetermined range and
whereby at the lower supporting surface, the housing may be loaded with the objects to be lifted and thereafter the motor may be activated causing the motor to turn the rotatable member to thereby lift the housing toward the origin.

2. The apparatus as recited in claim 1 wherein the motor is an electric motor and the power source is at least one battery.

3. The apparatus as recited in claim 2 wherein the at least one battery is rechargeable.

4. The apparatus as recited in claim 1 wherein at least one of the motor and the power source is detachable from the housing.

5. The apparatus as recited in claim 1 further including a controller supported by the housing for controlling the application of power from the power source to the motor.

6. The apparatus as recited in claim 5 wherein the controller is a wireless controller to facilitate remote control of the operation of the motor.

7. The apparatus as recited in claim 1 wherein the free end of the cable includes one of a carabiner, a hook and a snap hook.

8. The apparatus as recited in claim 1 wherein the housing includes a cargo bin for receiving and supporting the objects, the cargo bin being detachable from the remainder of the housing.

9. The apparatus as recited in claim 1 wherein the housing comprises a protective screen.

10. The apparatus as recited in claim 1 wherein the housing is generally raindrop shaped.

11. The apparatus as recited in claim 1 wherein the cable comprises steel wire rope.

12. The apparatus as recited in claim 1 wherein the descent-slowing, energy dissipating mechanism comprises an air resistance device.

13. The apparatus as recited in claim 1 further comprising a brake for preventing the housing from ascending or descending.

14. The apparatus as recited in claim 1 wherein the housing further includes an attachment member for receiving and retaining a hose for lifting the hose toward the origin.

15. A method of lifting objects from a lower supporting surface to or nearer to an origin at a predetermined height in a multistory building, the method comprising:
storing at or near the origin a light weight housing of sufficient strength for receiving and supporting the objects to be lifted, the housing including a cable wound at least partially onto a rotatable member supported by the housing, the cable having a predetermined length sufficient to reach at least from the origin to the lower supporting surface and having a free end for securing the cable to a fixed anchorage proximate to the origin, the rotatable member rotating in a first direction when the housing is descending toward the lower supporting surface and a descent-slowing, energy dissipating mechanism supported by the housing and driven by rotation of the rotatable member in the first direction, the descent-slowing, energy dissipating mechanism dissipating energy when the housing is descending toward the lower supporting surface to maintain the rate of descent of the housing to be within a predetermined range;
securing the free end of the cable to the fixed anchorage;
dropping the housing out of a window or other opening in the building so that the housing descends under at least its own weight toward the lower supporting surface at a descent rate within the predetermined range;
at the lower supporting surface securing a motor and a power source to the housing, the motor being supported by the housing and operatively engaged with the rotatable member for rotating the rotatable member in a second direction, opposite to the first direction, for lifting the housing toward the origin and the power source supported by the housing for providing power to the motor;
loading the housing with the objects to be lifted; and
activating the motor to lift the housing with the objects toward the origin

16. The method as recited in claim 15 further including the step of securing a wireless controller to the motor and the power source at the lower supporting surface.

17. The method as recited in claim 15 further including the step of securing a cargo bin to the housing at the lower supporting surface, the cargo bin for receiving the objects to be lifted.
